(19) United States
(12) Patent Application Publication
(10) Pub. No.: US 2013/0051659 A1
(43) Pub. Date: Feb. 28, 2013

(54) STEREOSCOPIC IMAGE PROCESSING DEVICE AND STEREOSCOPIC IMAGE PROCESSING METHOD

(71) Applicant: Junya Yamamoto, Osaka (JP)

(72) Inventor: Junya Yamamoto, Osaka (JP)

(73) Assignee: PANASONIC CORPORATION, Osaka (JP)

(21) Appl. No.: 13/643,441

(22) PCT Filed: Jan. 26, 2011
(86) PCT No.: PCT/JP2011/000394

§ 371 Date: Oct. 25, 2012

(30) Foreign Application Priority Data
Apr. 28, 2010 (JP) 2010-103294

(51) Int. Cl. G06T 15/00

(52) U.S. Cl. 382/154

(57) ABSTRACT

A stereoscopic image processing device that converts a two-dimensional (2D) image into a three-dimensional (3D) image includes: a detector detecting a value indicating a variation degree of an image feature quantity within a current frame to be processed of the 2D image; a normalizer (a) normalizing the image feature quantity to approximate the value detected by the detector to a threshold of the variation degree and outputting the normalized image feature quantity when the value is smaller than the threshold of the variation degree; and (b) not normalizing the image feature quantity and outputting the image feature quantity when the value is larger than or equal to the threshold of the variation degree; and a depth information generator generating depth information for converting the 2D image into the 3D image, based on the image feature quantity output by the normalizer.

### TECHNICAL FIELD

The present invention relates to a stereoscopic image processing device that converts a two-dimensional (2D) image signal into a three-dimensional (3D) image signal, and in particular to a stereoscopic image processing device that generates depth information from the 2D image signal.

### BACKGROUND ART

Conventionally, image display devices such as liquid crystal panels have been used as devices that display 2D images. Meanwhile, stereoscopic image display devices that receive 3D images having a parallax and are incorporated into active shutter glasses or polarizers have been developed and on the market. Such stereoscopic image display devices enable the users to view the 3D images.

In recent years, research and development on stereoscopic image display devices that display 3D images generated from 2D images have been progressed. For example, according to PTL 1, parallax information of each region in a 2D image is calculated using an image feature quantity on perspective in an image, such as luminance and chroma, thus generating a 3D image. Furthermore, PTL 1 discloses a function for enabling the user to select an emphasized feeling in generating a 3D image by multiplying, by an image feature quantity, a gain determined by an input sensitive word.

### CITATION LIST

### Patent Literature

[PTL 1] Japanese Unexamined Patent Application Publication No.

### SUMMARY OF INVENTION

### Technical Problem

However, the conventional technique has a problem that the quality of a stereoscopic image cannot fully be improved.

For example, according to the technique of PTL 1, when parallax information is calculated for each region using an image feature quantity on perspective in an image, a gain for each image feature quantity is determined regardless of an input image. Thus, for example, when an image having a smaller variance in luminance value is fed in performing conversion that emphasizes luminance, there is another problem that a depth is constant entirely on the image and a stereoscopic effect is reduced.

In order to solve the problem, the technique disclosed in PTL 1 normalizes the luminance value. However, there is a problem that the normalization causes an error due to proliferation of originally insufficient information, or too much emphasis on luminance results in a 3D image with uncomfortable feeling.

Thus, the present invention has an object of providing a stereoscopic image processing device and a stereoscopic image processing method which enable sufficient improvement in the quality of a stereoscopic image.

### Solution to Problem

In order to solve the problems, a stereoscopic image processing device according to an aspect of the present invention is a stereoscopic image processing device that converts a two-dimensional (2D) image into a three-dimensional (3D) image, the device including: a detector detecting a value indicating a variation degree of an image feature quantity within a current frame to be processed of the 2D image; a normalizer: (a) normalizing the image feature quantity to approximate the value detected by the detector to a threshold of the variation degree and outputting the normalized image feature quantity when the value is smaller than the threshold of the variation degree; and (b) not normalizing the image feature quantity and outputting the image feature quantity when the value is larger than or equal to the threshold of the variation degree; and a depth information generator generating depth information for converting the 2D image into the 3D image, based on the image feature quantity output by the normalizer.

Thus, when the value indicating the variation degree of the image feature quantity is smaller than the threshold, the image feature quantity is normalized so that the value approximates the threshold, that is, the value does not exceed the threshold. Thus, the image feature quantity can be appropriately normalized. In other words, it is possible to prevent the image feature quantity with insufficient information from being normalized (expanded) more than necessary, and to suppress decrease in the reliability of the image feature quantity. Thus, the quality of a stereoscopic image can be fully improved.

Furthermore, the image feature quantity may include a first image feature quantity and a second image feature quantity that are different from each other, the detector may detect a first value indicating a variation degree of the first image feature quantity, and a second value indicating a variation degree of the second image feature quantity, the normalizer: (i) (a) may normalize the first image feature quantity to approximate the first value detected by the detector to a first threshold of the variation degree of the first image feature quantity and output the normalized first image feature quantity when the first value is smaller than the first threshold of the variation degree, and (b) may not normalize the first image feature quantity and output the first image feature quantity when the first value is larger than or equal to the first threshold of the variation degree of the first image feature quantity; and (ii) (a) may normalize the second image feature quantity to approximate the second value detected by the detector to a second threshold of the variation degree of the second image feature quantity and output the normalized second image feature quantity when the second value is smaller than the second threshold of the variation degree, and (b) may not normalize the second image feature quantity and output the second image feature quantity when the second value is larger than or equal to the second threshold of the variation degree of the second image feature quantity, the stereoscopic image processing device may further include a combiner calculating a weighted sum of the first image feature quantity and the second image feature quantity that are output by the normalizer, and generating a combined image feature quantity, the depth information generator may generate the depth information by multiplying the combined image feature quantity by a predetermined coefficient, and the combiner may calculate the weighted sum (a) weighting the first image feature quantity more heavily than the second image feature quantity when the first value is larger than the second value, and (b) weighting the second image feature quantity more heavily than the first image feature quantity when the second value is larger than the first value.

Thus, when depth information is generated using image feature quantities, one of the image feature quantities whose value indicating the variation degree is larger can be more influential. In other words, use of an image feature quantity with low reliability can be suppressed when the depth information is generated, and the depth information with high precision can be generated.

Furthermore, the detector may detect, as the first value, a difference between a maximum value and a minimum value of the first image feature quantity or a variance of the first image feature quantity, and detect, as the second value, a difference between a maximum value and a minimum value of the second image feature quantity or a variance of the second image feature quantity.

The fact that a difference between the maximum value and the minimum value or a variance is smaller than a threshold indicates that information is insufficient. Thus, normalization of the variance with approximation to the threshold can prevent the image feature quantity from being normalized (expanded) more than necessary, and suppress decrease in the reliability of the image feature quantity.

Furthermore, the image feature quantity may indicate at least one of luminance information and chroma information within the current frame, and the detector may detect, as the value indicating the variation degree, at least one of a luminance difference value and a chroma difference value, the luminance difference value being a difference between a maximum value and a minimum value of the luminance information, and the chroma difference value being a difference between a maximum value and a minimum value of the chroma information.

The fact that the luminance difference value or the chroma difference value is smaller than a threshold indicates that information is insufficient. Thus, normalization of the luminance difference value or the chroma difference value with approximation to the threshold can prevent the image feature quantity from being normalized (expanded) more than necessary, and suppress decrease in the reliability of the luminance information or the chroma information.

Furthermore, the normalizer may normalize at least one of the luminance information and the chroma information to set at least one of the luminance difference value and the chroma difference value to be equal to the threshold of the variation degree, when the at least one of the luminance difference value and the chroma difference value is smaller than the threshold of the variation degree.

Since the luminance information or the chroma information is normalized so that the luminance difference value or the chroma difference value is equal to the threshold, it is possible to prevent the normalization (expansion) more than necessary over the threshold, and suppress decrease in the reliability of the luminance information or the chroma information.

Furthermore, the detector may include: a luminance extractor extracting the luminance information; and a luminance difference calculator calculating the difference between the maximum value and the minimum value of the luminance information extracted by the luminance extractor, to detect the luminance difference value, the normalizer may include: a storage storing the threshold; a luminance comparator comparing the luminance difference value with the threshold to determine whether or not the normalizer normalizes the luminance information; a luminance value integrator dividing the luminance information into a plurality of blocks and integrating luminance values for each of the blocks to calculate a luminance integrated value for the block; and a luminance value normalizer: (a) normalizing and outputting the luminance integrated value when the luminance comparator determines that the normalizer normalizes the luminance information; and (b) not normalizing the luminance integrated value and outputting the luminance integrated value when the luminance comparator determines that the normalizer does not normalize the luminance information, and the depth information generator may generate the depth information based on the luminance integrated value output by the luminance value normalizer.

Accordingly, the depth information can be generated from the luminance information. For example, the depth information generator generates the depth information indicating an amount of projection with which an image seems to project more from the screen as the luminance is higher.

Furthermore, the detector may further include: a chroma extractor extracting the chroma information; and a chroma difference calculator calculating the difference between the maximum value and the minimum value of the chroma information extracted by the chroma extractor, to detect the chroma difference value, the normalizer may further include: a chroma comparator comparing the chroma difference value with the threshold of the variation degree to determine whether or not the normalizer normalizes the chroma information; a chroma value integrator dividing the chroma information into a plurality of blocks and integrate chroma values for each of the blocks to calculate a chroma integrated value for the block; and a chroma value normalizer: (a) normalizing and outputting the chroma integrated value when the chroma comparator determines that the normalizer normalizes the chroma information; and (b) not normalizing the chroma integrated value and outputting the chroma integrated value when the chroma comparator determines that the normalizer does not normalize the chroma information, the stereoscopic image processing device may further include a combiner calculating a weighted sum of the luminance integrated value output by the luminance value normalizer and the chroma integrated value output by the chroma value normalizer, to generate a combined image feature quantity, and the depth information generator may generate the depth information by multiplying, by a predetermined coefficient, the combined image feature quantity generated by the combiner.

Since depth information is generated from the luminance information and the chroma information, depth information with higher precision can be generated.

Furthermore, the combiner may calculate the weighted sum weighting the luminance integrated value output by the luminance value normalizer more heavily than the chroma integrated value output by the chroma value normalizer when the luminance difference value is larger than the chroma difference value, and weighting the chroma integrated value more heavily than the luminance integrated value when the chroma difference value is larger than the luminance difference value.

Since an image feature quantity with a larger difference between the maximum value and the minimum value is heavily weighted, such an image feature quantity can be more influential. The larger difference between the maximum value and the minimum value indicates higher reliability. Thus, depth information can be generated based on the information with higher reliability.

Furthermore, the stereoscopic image processing device may further include: a coefficient generator generating a luminance coefficient to be multiplied by the luminance integrated value output by the luminance value normalizer, and a chroma coefficient to be multiplied by the chroma integrated value output by the chroma value normalizer; and a memory storing the luminance coefficient and the chroma coefficient that are used for a frame previous to the current frame, and the coefficient generator may include: a coefficient setter setting the luminance coefficient and the chroma coefficient to set the luminance coefficient to be larger than the chroma coefficient when the luminance difference value is larger than the chroma difference value, and to set the chroma coefficient to be larger than the luminance coefficient when the chroma difference value is larger than the luminance difference value; and a limiter correcting the luminance coefficient and the chroma coefficient set by the coefficient setter to maintain, within a predetermined range, a difference between the luminance coefficient set by the coefficient setter and the luminance coefficient used for the previous frame and a difference between the chroma coefficient set by the coefficient setter and the chroma coefficient used for the previous frame.

Since a variation from the previous frame can be suppressed within a predetermined range, abrupt change in depth can be suppressed, and the eye fatigue of the viewer can be reduced.

Furthermore, the detector may include: a chroma extractor extracting the chroma information; and a chroma difference calculator calculating the difference between the maximum value and the minimum value of the chroma information extracted by the chroma extractor, to detect the chroma difference value, the normalizer may include: a storage storing the threshold; a chroma comparator comparing the chroma difference value with the threshold to determine whether or not the normalizer normalizes the chroma information; a chroma value integrator dividing the chroma information into a plurality of blocks and integrate chroma values for each of the blocks to calculate a chroma integrated value for the block; and a chroma value normalizer: (a) normalizing and outputting the chroma integrated value when the chroma comparator determines that the normalizer normalizes the chroma information; and (b) not normalizing the chroma integrated value and outputting the chroma integrated value when the chroma comparator determines that the normalizer does not normalize the chroma information, and the depth information generator may generate the depth information based on the chroma integrated value output by the chroma value normalizer.

Accordingly, the depth information can be generated from the chroma information. For example, the depth information generator generates the depth information indicating an amount of projection with which an image seems to project more from the screen as the chroma is higher.

Furthermore, the image feature quantity may indicate at least one of luminance information and chroma information within the current frame, and the detector may detect, as the value indicating the variation degree, at least one of a variance of the luminance information and a variance of the chroma information.

The fact that a variance is smaller than a threshold indicates that information is insufficient. Thus, normalization of the variance with approximation to the threshold can prevent the information from being normalized (expanded) more than necessary, and suppress decrease in the reliability of the information.

Furthermore, the stereoscopic image processing device may further include a scene change detector determining whether or not the current frame is a frame in which a scene has been changed, and the depth information generator may generate the depth information only when the scene change detector determines that the current frame is not the frame in which the scene has been changed, out of cases where the scene change detector determines that the current frame is the frame in which the scene has been changed and that the current frame is not the frame in which the scene has been changed.

Before or after the scene is changed, variation in the depth information is larger. Thus, when the current frame is a frame in which a scene has been changed, the depth information is not generated. In other words, output of the current frame as a 2D image can reduce the eye fatigue of the viewer.

Furthermore, the stereoscopic image processing device may further include a face detector detecting a face region from the current frame, wherein the depth information generator may include: a first depth information generator generating first depth information that is depth information of the face region; a second depth information generator generating second depth information that is depth information of a region at least other than the face region, based on the image feature quantity output by the normalizer; and a depth information combiner combining the first depth information and the second depth information to generate the depth information for converting the 2D image into the 3D image.

Since depth information of the detected face region is generated based on not the image feature quantity but exclusive processing, the depth information with higher precision can be generated.

Furthermore, the depth information generator may further include: a face surrounding region extractor extracting a surrounding region that surrounds the face region; and an offset calculator obtaining depth information of the surrounding region from the second depth information, and calculating an offset value for approximating the depth information of the face region to the obtained depth information of the surrounding region, based on the depth information of the surrounding region, and the first depth information generator may generate the first depth information based on predetermined depth information and the offset value.

Since the depth information of the face region can approximate to the depth information of the surrounding region, a stereoscopic image with less uncomfortable feeling can be generated.

Furthermore, the face surrounding region extractor may extract, as the surrounding region, a region below the face region or a region above and to the left and right of the face region.

Since the body of a subject is often present in the region below the face region, depth information of the body can approximate to the depth information of the face region, and a stereoscopic image with less uncomfortable feeling can be generated.

The present invention can be implemented not only as a stereoscopic image processing device but also as a method using processors included in the stereoscopic image processing device as steps. Furthermore, the present invention may be implemented as a program causing a computer to execute these steps. Furthermore, the present invention can be implemented as a recording medium on which the program is recorded, such as a computer-readable compact disc-read only memory (CD-ROM), and as information, data, or a signal that indicates the program. Furthermore, these program, information, data, and signal may be distributed through a communication network, such as the Internet.

Furthermore, a part or all of the constituent elements included in the stereoscopic image processing device may be configured from a single System-Large-Scale Integration (LSI). The System-LSI is a super-multi-function LSI manufactured by integrating constituent elements on one chip, and is specifically a computer system configured by including a microprocessor, a ROM, and a Random Access Memory (RAM).

### Advantageous Effects of Invention

Thus, the stereoscopic image processing device and the stereoscopic image processing method according to the present invention can fully improve the quality of a stereoscopic image.

### BRIEF DESCRIPTION OF DRAWINGS

FIG. 1 illustrates an example of a configuration of a stereoscopic image viewing system according to an embodiment of the present invention.

FIG. 2 is a block diagram illustrating an example of a configuration of a stereoscopic image display device according to the embodiment.

FIG. 3 is a block diagram illustrating an example of a configuration of an image signal processor according to the embodiment.

FIG. 4 is a block diagram illustrating an example of a configuration of a 2D-3D conversion circuit according to the embodiment.

FIG. 5 illustrates a process for calculating a luminance integrated value and a chroma integrated value according to the embodiment.

FIG. 6 illustrates a normalization selecting process according to the embodiment.

FIG. 7 is a block diagram illustrating an example of a configuration of a parameter selection coefficient setting circuit according to the embodiment.

FIG. 8 illustrates an example of a coefficient setting process according to the embodiment.

FIG. 9 is a block diagram illustrating an example of a configuration of a feature quantity combining circuit according to the embodiment.

FIG. 10 illustrates change in value in a feature quantity combining process according to the embodiment.

FIG. 11 is a block diagram illustrating an example of a configuration of a depth information generating circuit according to the embodiment.

FIG. 12 illustrates change in value in a depth information generating process according to the embodiment.

FIG. 13 is a flowchart indicating an example of processes performed by the stereoscopic image processing device according to the embodiment.

FIG. 14 is a block diagram illustrating an example of a configuration of a stereoscopic image processing device according to a modification of the embodiment.

### DESCRIPTION OF EMBODIMENT

An embodiment of a stereoscopic image processing device according to the present invention will be described with reference to drawings.

The stereoscopic image processing device according to the embodiment is a stereoscopic image processing device for converting a 2D image into a 3D image, and includes a detector, a normalizer, and a depth information generator. The detector detects a value indicating a variation degree of an image feature quantity within a current frame to be processed of the 2D image. The normalizer normalizes the image feature quantity so that the value detected by the detector approximates a threshold and outputs the normalized image feature quantity when the value is smaller than the threshold, and does not normalize the image feature quantity and outputs the image feature quantity when the value is larger than or equal to the threshold. The depth information generator generates depth information for converting the 2D image into the 3D image, based on the image feature quantity output by the normalizer, that is, based on the normalized image feature quantity or the image feature quantity that is not normalized.

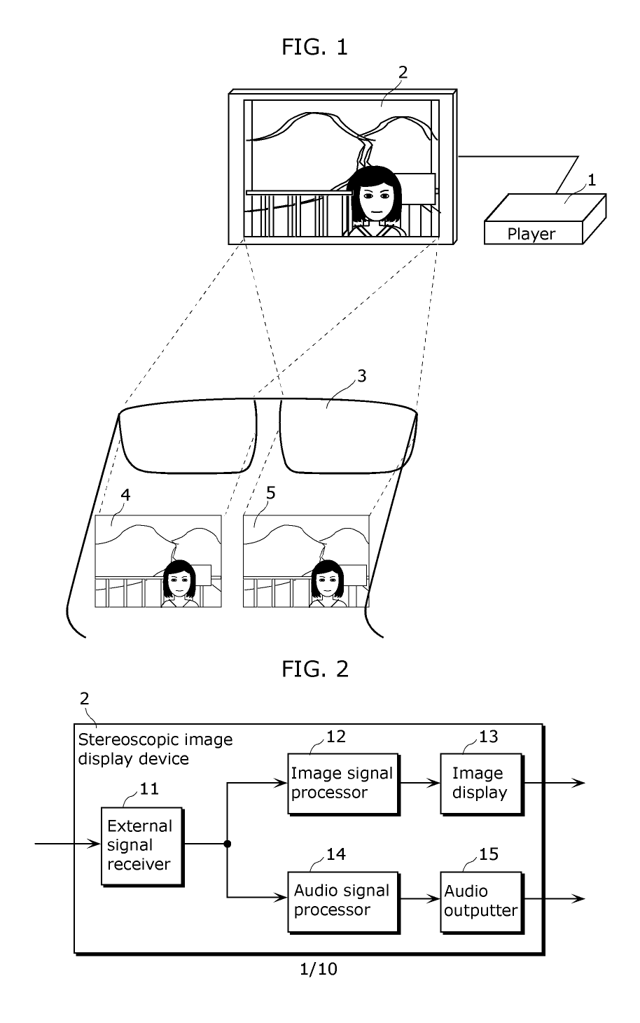

FIG. 1 illustrates an example of a configuration of a stereoscopic image viewing system according to the embodiment. As illustrated in FIG. 1, the stereoscopic image viewing system includes a player 1, a stereoscopic image display device 2, and active shutter glasses 3.

The player 1 is an example of an image playback apparatus, and plays back a 2D image (two dimensional image or planar image) and transmits an image signal to the stereoscopic image display device 2 through a High-Definition Multimedia Interface (HDMI) cable. For example, the player 1 includes a Hard Disk (HD) drive for storing an image content or an antenna for receiving broadcast waves. Then, the player 1 obtains an image content from an external recording medium, such as a HD drive or a Blu-ray Disc (BD^{(R)}), or from the broadcast waves received through the antenna. The player 1 transmits the obtained image content to the stereoscopic image display device 2 as a 2D image signal.

The stereoscopic image display device 2 receives the 2D image signal output by the player 1, and converts the received 2D image signal into a stereoscopic image. The stereoscopic image according to the embodiment includes a left-eye image 4 and a right-eye image 5 that have a parallax. The viewer (user) views the left-eye image 4 with the left eye and the right-eye image 5 with the right eye, using the active shutter glasses 3, so that the user can stereoscopically view the 3D moving image. For example, the stereoscopic image display device 2 alternately displays the left-eye image 4 and the right-eye image 5 per frame.

The active shutter glasses 3 operate in synchronization with the display timing of images by the stereoscopic image display device 2. More specifically, when the stereoscopic image display device 2 displays the left-eye image 4, the active shutter glasses 3 prevent light from entering the right eye and pass the light only through the left eye. Conversely, when the stereoscopic image display device 2 displays the right-eye image 5, the active shutter glasses 3 prevent light from entering the left eye and pass the light only through the right eye. With the operation accelerated, the viewer who wears the active shutter glasses 3 can view the left-eye image 4 with the left eye, and the right-eye image 5 with the right eye. With an appropriate parallax between the left-eye image 4 and the right-eye image 5, the viewer can view a stereoscopic image.

An image signal may be fed to the stereoscopic image display device 2 through a D terminal cable or a coaxial cable for transmitting broadcast waves. Furthermore, the stereoscopic image display device 2 can feed the image signal not only in a wired manner but also wirelessly. Furthermore, the number of viewpoints of images displayed by the stereoscopic image display device 2 may be three or more. Furthermore, the stereoscopic image display device 2 may be a volumetric display device that three-dimensionally displays voxels.

The techniques using the stereoscopic image display device 2 and the active shutter glasses 3 for enabling the user to view different images with the left eye and the right eye may include a polarization scheme that outputs a left-eye image and a right-eye image from the stereoscopic image display device 2 in different polarization schemes, and separates the images by polarizing glasses. Alternatively, the techniques may include a method for separating images using a parallax barrier or a lenticular sheet. Alternatively, the techniques may include a method for displaying images viewed from different viewpoints according to the position of the observer, when the number of viewpoints of images displayed by the stereoscopic image displaying apparatus 2 may be one or more.

FIG. 2 is a block diagram illustrating an example of a configuration of the stereoscopic image viewing apparatus 2 according to the embodiment. As illustrated in FIG. 2, the stereoscopic image display device 2 includes an external signal receiver 11, an image signal processor 12, an image display 13, an audio signal processor 14, and an audio outputter 15.

The external signal receiver 11 receives an input signal output by the player 1 through the HDMI cable, decodes a data frame in the received input signal, and outputs a signal, such as an image signal and an audio signal.

The external signal receiver 11 supplies the image signal to the video signal processor 12. The image signal processor 12 enlarges or reduces an image, converts a 2D image into a 3D image (a planar image into a pseudo-stereoscopic image), and outputs 3D image data indicating images viewed from two viewpoints. The detailed configuration of the image signal processor 12 will be described later.

The image display 13 receives the images of the two viewpoints output from the image signal processor 12, and alternately displays the left-eye image and the right-eye image per frame. The image display 13 may be, for example, a liquid crystal display, a plasma display panel, or an organic EL display panel.

The audio signal processor 14 receives the audio signal output by the external signal receiver 11, and performs sound quality processing and others.

The audio outputter 15 outputs, as audio, the audio signal output by the audio signal processor 14. The audio outputter 15 is, for example, a speaker.

The external signal receiver 11 and an HDMI signal that is an input signal thereof may be replaced with a tuner and broadcast waves, respectively.

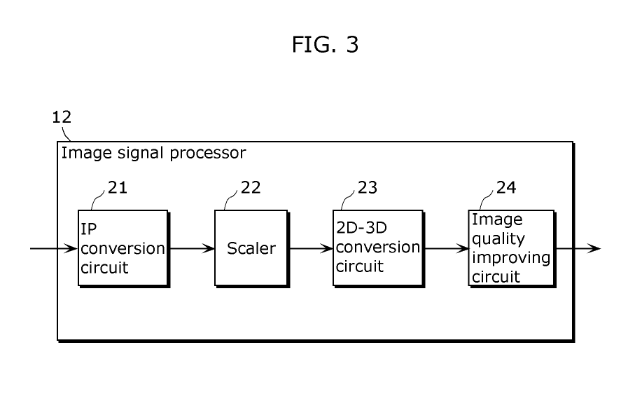

FIG. 3 is a block diagram illustrating an example of a configuration of the image signal processor 12 according to the embodiment. As illustrated in FIG. 3, the image signal processor 12 includes an IP conversion circuit 21, a scaler 22, a 2D-3D conversion circuit 23, and an image quality improving circuit 24.

The IP conversion circuit 21 performs IP conversion for converting an interlaced image signal provided from the external signal receiver 11 into a progressive image signal.

When the resolution of the image output by the IP conversion circuit 21 is different from that of the image to be finally displayed on the image display 13, the scaler 22 enlarges or reduces the image to output the image data according to the resolution of the image display 13.

The 2D-3D conversion circuit 23 receives the 2D image data output by the scaler 22, and converts the received 2D image data into 3D image data. For example, the 2D-3D conversion circuit 23 outputs an image signal indicating images viewed from two viewpoints, as the 3D image data. The detailed configuration of the 2D-3D conversion circuit 23 will be described later.

The image quality improving circuit 24 performs image quality improvement processing, such as gamma processing and edge enhancement processing, on image data of each viewpoint output by the 2D-3D conversion circuit 23 to output resulting image signals.

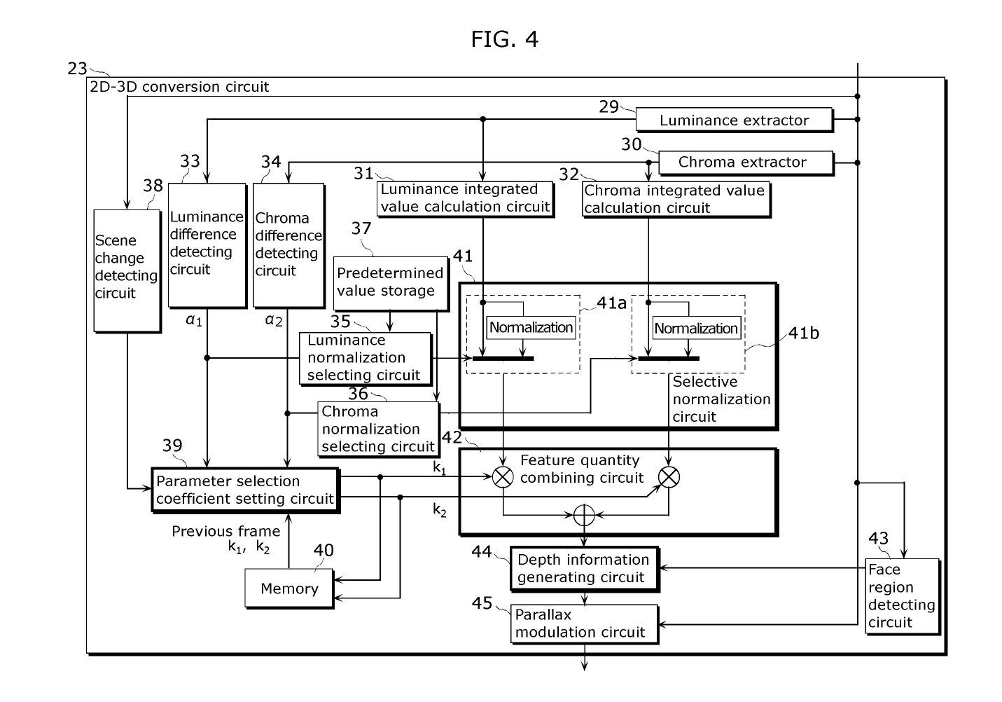

FIG. 4 is a block diagram illustrating an example of a configuration of the 2D-3D conversion circuit 23 according to the embodiment. As illustrated in FIG. 4, the 2D-3D conversion circuit 23 includes a luminance extractor 29, a chroma extractor 30, a luminance integrated value calculation circuit 31, a chroma integrated value calculation circuit 32, a luminance difference detecting circuit 33, a chroma difference detecting circuit 34, a luminance normalization selecting circuit 35, a chroma normalization selecting circuit 36, a predetermined value storage 37, a scene change detecting circuit 38, a parameter selection coefficient setting circuit 39, a memory 40, a selective normalization circuit 41, a feature quantity combining circuit 42, a face region detecting circuit 43, a depth information generating circuit 44, and a parallax modulation circuit 45.

The luminance extractor 29 extracts luminance information within the current frame of the 2D image. More specifically, the luminance extractor 29 extracts only a luminance component from the image signal output by the scaler 22, and outputs the luminance component as luminance data. The luminance data is, for example, luminance information indicating a luminance value for each pixel within one frame of the 2D image. The luminance information is an example of the first image feature quantity, and is used for generating depth information of an image.

The chroma extractor 30 extracts chroma information within the current frame of the 2D image. More specifically, the chroma extractor 30 extracts only a chroma component from the image data output by the scaler 22, and outputs the chroma component as chroma data. The chroma data is, for example, chroma information indicating a chroma value for each pixel within one frame of the 2D image. The chroma information is an example of the second image feature quantity, and is used for generating depth information of an image.

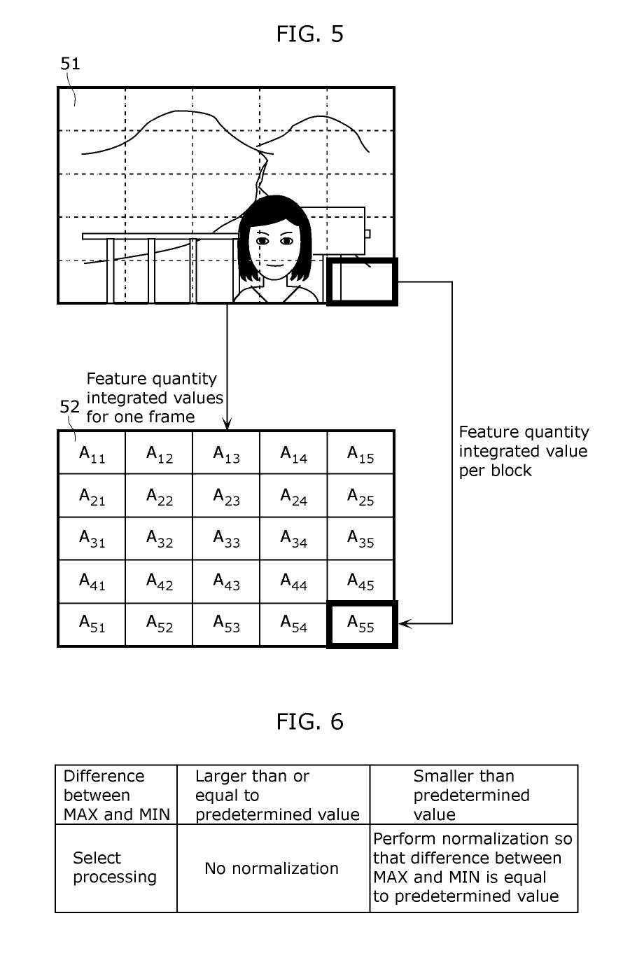

The luminance integrated value calculation circuit 31 is an example of a luminance value integrator, and calculates a luminance integrated value for each block by dividing the luminance information extracted by the luminance extractor 29 into a plurality of blocks and integrating luminance values for each of the blocks. Specifically, the luminance integrated value calculation circuit 31 calculates a total of the luminance values included in the luminance data output by the luminance extractor 29. More specifically, the luminance integrated value calculation circuit 31 divides a 2D image 51 into a plurality of blocks 52, and calculates the total of luminance values as a luminance integrated value for each of the blocks, as illustrated in FIG. 5.

The chroma integrated value calculation circuit 32 is an example of a chroma value integrator, and calculates a chroma integrated value for each block by dividing the chroma information extracted by the chroma extractor 30 into a plurality of blocks and integrating chroma values for each of the blocks. Specifically, the chroma integrated value calculation circuit 32 calculates a total of the chroma values included in the chroma data output by the chroma extractor 30. More specifically, the chroma integrated value calculation circuit 32 divides a 2D image into a plurality of blocks, and calculates the total of chroma values as a chroma integrated value for each of the blocks, in the same manner as the luminance integrated value calculation circuit 31.

The luminance difference detecting circuit 33 is an example of a luminance difference calculator, and calculates a difference between the maximum value and the minimum value of the luminance information extracted by the luminance extractor 29, to detect a luminance difference value. More specifically, the luminance difference detecting circuit 33 calculates and outputs a luminance difference value α₁ that is a difference between the maximum value and the minimum value of the luminance data output by the luminance extractor 29. The luminance difference value α₁ corresponds to a spreading width of luminance information within the current frame. In other words, the luminance difference detecting circuit 33 calculates a difference between the maximum value and the minimum value of a luminance value within the current frame, and outputs the calculated difference as the luminance difference value α₁.

The chroma difference detecting circuit 34 is an example of a chroma difference calculator, and calculates a difference between the maximum value and the minimum value of the chroma information extracted by the chroma extractor 30, to detect a chroma difference value. More specifically, the chroma difference detecting circuit 34 calculates and outputs a chroma difference value α₂ that is a difference between the maximum value and the minimum value of the chroma data output by the chroma extractor 30. The chroma difference value α₂ corresponds to a spreading width of chroma information within the current frame. In other words, the chroma difference detecting circuit 33 calculates a difference between the maximum value and the minimum value of the chroma value within the current frame, and outputs the calculated difference as the chroma difference value α₂.

Here, before calculating the difference between the maximum value and the minimum value, a histogram of an image feature quantity (luminance information and chroma information) may be obtained, and processing for eliminating data of several percent around the histogram may be added.

The luminance normalization selecting circuit 35 is an example of a luminance comparator, and compares the luminance difference value α₁ with a predetermined first threshold to determine whether or not the luminance information is normalized. More specifically, the luminance normalization selecting circuit 35 compares the luminance difference value α₁ output by the luminance difference detecting circuit 33 with a predetermined value for selecting the normalization that is output by the predetermined value storage 37. Then, the luminance normalization selecting circuit 35 determines whether or not the luminance integrated value needs to be normalized, and outputs a result on the luminance normalization processing. The result on the luminance normalization processing is information indicating whether or not the luminance value is to be normalized.

The chroma normalization selecting circuit 36 is an example of a chroma comparator, and compares the chroma difference value α₂ with a predetermined second threshold to determine whether or not the chroma information is normalized. More specifically, the chroma normalization selecting circuit 36 compares the chroma difference value α₂ output by the chroma difference detecting circuit 34 with a predetermined value for selecting the normalization that is output by the predetermined value storage 37. Here, the predetermined value (first threshold) used by the luminance normalization selecting circuit 35 does not have to be identical to the predetermined value (second threshold) used by the chroma normalization selecting circuit 36. Then, the chroma normalization selecting circuit 36 determines whether or not the chroma integrated value needs to be normalized, and outputs a result on the chroma normalization processing. The result on the chroma normalization processing is information indicating whether or not the chroma value is to be normalized.

FIG. 6 illustrates an example of a method for determining normalization selecting processing according to the embodiment.

When the difference between the maximum value and the minimum value of each feature quantity is smaller than a predetermined value for selecting normalization, each of the luminance normalization selecting circuit 35 and the chroma normalization selecting circuit 36 selects “requiring” the normalization so that a difference between the maximum value and the minimum value is set to the predetermined value in the normalization. In contrast, when the difference between the maximum value and the minimum value is larger than or equal to the predetermined value, each of the luminance normalization selecting circuit 35 and the chroma normalization selecting circuit 36 selects “not requiring” the normalization so that the normalization is not performed. Each of the luminance normalization selecting circuit 35 and the chroma normalization selecting circuit 36 outputs the result of the selection to the selective normalization circuit 41.

In other words, the luminance normalization selecting circuit 35 determines that the luminance value needs to be normalized when the luminance difference value α₁ is smaller than a threshold, and determines that the luminance value does not need to be normalized when the luminance difference value α₁ is larger than or equal to the threshold. In other words, the luminance normalization selecting circuit 35 outputs a result of the determination indicating that no normalization is performed when the luminance difference value α₁ is smaller than the threshold, and outputs a result of the determination indicating that normalization is performed when the luminance difference value α₁ is larger than or equal to the threshold.

Similarly, the chroma normalization selecting circuit 36 determines that the chroma value needs to be normalized when the chroma difference value α₂ is smaller than a threshold, and determines that the chroma value does not need to be normalized when the chroma difference value α₂ is larger than or equal to the threshold. In other words, the chroma normalization selecting circuit 36 outputs a result of the determination indicating that no normalization is performed when the chroma difference value α₂ is smaller than the threshold, and outputs a result of the determination indicating that normalization is performed when the chroma difference value α₂ is larger than or equal to the threshold.

When the difference between the maximum value and the minimum value of each feature quantity is smaller and normalization is performed more than necessary, the quality of depth information to be finally generated is degraded because the originally insufficient information of the feature quantity is forcibly enlarged. When the difference between the maximum value and the minimum value of the feature quantity is larger and even no normalization is performed, sufficiently high-quality depth information can be generated.

Without performing normalization in the case where the difference between the maximum value and the minimum value is smaller, the depth information to be generated is almost two-dimensional information, and the stereoscopic effect is lost. Thus, the feature quantity information can be normalized without greatly decreasing the reliability by limiting the quantity to be normalized within a predetermined range and not performing the normalization when the difference between the maximum value and the minimum value is larger than or equal to a predetermined value.

The predetermined value storage 37 is a storage that stores a predetermined value to be a threshold for determining whether or not an image feature quantity is to be normalized. The predetermined value may differ for each image feature quantity.

The scene change detecting circuit 38 is an example of a scene change detector, and determines whether or not the current frame is a frame in which a scene has been changed. More specifically, the scene change detecting circuit 38 receives the image data output by the scaler 22, determines whether or not the image data that is currently input indicates images in which the scene has been changed, and outputs a scene-change detection result.

For example, when a scene is changed, variation in the average of the luminance values within one frame prior or subsequent to the change in the scene is larger. Thus, the scene change detecting circuit 38 compares an average of luminance values of the current frame with an average of luminance values of a frame previous to the current frame, and determines the current frame as a frame in which the scene has been changed when the variation is larger than or equal to a predetermined threshold. The scene change detecting circuit 38 may determine consecutive frames including the current frame as frames in each of which a scene has been changed.

Furthermore, when a user captures images and a stream includes information indicating start of the capturing, the scene change detecting circuit 38 may determine whether or not the current frame is a frame in which a scene has been changed by detecting the information.

The parameter selection coefficient setting circuit 39 receives (i) the luminance difference value α₁ and the chroma difference value α₂ from the luminance difference detecting circuit 33 and the chroma difference detecting circuit 34, respectively, (ii) the scene-change detection result from the scene change detecting circuit 38, and (iii) values of a luminance coefficient k₁ and a chroma coefficient k₂ of the previous frame output from the memory 40, and outputs the luminance coefficient k₁ and the chroma coefficient k₂ of the current frame. The detailed configuration of the parameter selection coefficient setting circuit 39 will be described later.

The memory 40 is a memory for storing the luminance coefficient k₁ and the chroma coefficient k₂ of the frame previous to the current frame. In other words, the memory 40 is a memory for storing the values of the luminance coefficient k₁ and the chroma coefficient k₂ output by the parameter selection coefficient setting circuit 39. Furthermore, the memory 40 outputs the luminance coefficient k₁ and the chroma coefficient k₂ that are stored, when the parameter selection coefficient setting circuit 39 calculates a luminance coefficient k₁ and a chroma coefficient k₂ of a frame next to the frame of the stored luminance coefficient k₁ and chroma coefficient k₂. These luminance coefficient k₁ and chroma coefficient k₂ will be described later.

The selective normalization circuit 41 selectively normalizes an image feature quantity based on a result of the comparison between a value indicating a variation degree in the image feature quantity and a threshold. In other words, the selective normalization circuit 41 is an example of a normalizer, and normalizes and outputs an image feature quantity so that a value indicating a variation degree of the image feature quantity approximates a threshold when the value is smaller than the threshold. Furthermore, the selective normalization circuit 41 does not normalize the image feature quantity and outputs the image feature quantity when the value is larger than or equal to the threshold.

More specifically, the selective normalization circuit 41 includes a luminance value normalization circuit 41a and a chroma value normalization circuit 41b.

The luminance value normalization circuit 41a is an example of a first image feature quantity normalizer, and normalizes and outputs the first image feature quantity so that a first value indicating a variation degree of the first image feature quantity approximates a first threshold when the first value is smaller than the first threshold. Furthermore, the luminance value normalization circuit 41a does not normalize the first image feature quantity and outputs the first image feature quantity when the first value is larger than or equal to the first threshold.

More specifically, the luminance value normalization circuit 41a is an example of a luminance value normalizer, and normalizes a luminance integrated value output by the luminance integrated value calculation circuit 31 and outputs the normalized luminance integrated value when the luminance normalization selecting circuit determines to normalize the luminance information. Furthermore, the luminance value normalization circuit 41a does not normalize the luminance integrated value output by the luminance integrated value calculation circuit 31, and outputs the luminance integrated value as it is when the luminance normalization selecting circuit 35 determines not to normalize the luminance information.

Hereinafter, the luminance integrated value output by the luminance value normalization circuit 41a will be referred to as a luminance feature quantity. In other words, the luminance feature quantity is a luminance integrated value normalized according to the luminance difference value, or a luminance integrated value that is not normalized.

The chroma value normalization circuit 41b is an example of a second image feature quantity normalizer, and normalizes and outputs the second image feature quantity so that a second value indicating a variation degree of the second image feature quantity approximates a second threshold when the second value is smaller than the second threshold. Furthermore, the chroma value normalization circuit 41b does not normalize the second image feature quantity and outputs the second image feature quantity when the second value is larger than or equal to the second threshold.

More specifically, the chroma value normalization circuit 41b is an example of a chroma value normalizer, and normalizes a chroma integrated value output by the chroma integrated value calculation circuit 32 and outputs the normalized chroma integrated value when the chroma normalization selecting circuit 36 determines to normalize the chroma information. Furthermore, the chroma value normalization circuit 41b does not normalize the chroma integrated value output by the chroma integrated value calculation circuit 32, and outputs the chroma integrated value as it is when the chroma normalization selecting circuit 36 determines not to normalize the chroma information.

Hereinafter, the chroma integrated value output by the chroma value normalization circuit 41b will be referred to as a chroma feature quantity. In other words, the chroma feature quantity is a chroma integrated value normalized according to the chroma difference value, or a chroma integrated value that is not normalized.

In other words, the selective normalization circuit 41 selectively normalizes the luminance integrated value output by the luminance integrated value calculation circuit 31, based on a result of the determination output by the luminance normalization selecting circuit 35, and outputs a luminance feature quantity. Similarly, the selective normalization circuit 41 selectively normalizes the chroma integrated value output by the chroma integrated value calculation circuit 32, based on a result of the determination output by the chroma normalization selecting circuit 36, and outputs a chroma feature quantity.

Here, the normalization means uniformly expanding or narrowing a range of values to a specific range, for example, a range of input values from 10 to 20 to a range from 0 to 30. When the luminance normalization selecting circuit 35 or the chroma normalization selecting circuit 36 determines not to normalize an image feature quantity, the selective normalization circuit 41 outputs the image feature quantity determined not to be normalized as an image feature quantity as it is.

The feature quantity combining circuit 42 is an example of a combiner, and calculates a weighted sum of the luminance integrated value output by the luminance value normalization circuit 41a and a chroma integrated value output by the chroma value normalization circuit 41b to generate a combined image feature quantity. More specifically, the feature quantity combining circuit 42 receives the image feature quantities output by the selective normalization circuit 41, and the luminance coefficient k₁ and the chroma coefficient k₂ output by the parameter selection coefficient setting circuit 39, multiplies each of the image feature quantities by a corresponding one of the luminance coefficient k₁ and the chroma coefficient k₂, and outputs the results. In other words, the feature quantity combining circuit 42 outputs combined image feature quantities by calculating a weighted sum of a luminance integrated value and a chroma integrated value using the luminance coefficient k₁ and the chroma coefficient k₂, respectively. The detailed configuration of the feature quantity combining circuit 42 will be described later.

The face region detecting circuit 43 is an example of a face detector, and detects a face region from the current frame of the 2D image. More specifically, the face region detecting circuit 43 detects a region that seems to be a face from the image data output by the scaler 22, and outputs a face region detection result including a position of the face region in the current frame and an orientation of the face.

The depth information generating circuit 44 generates depth information for converting a 2D image into a 3D image based on the image feature quantity output by the selective normalization circuit 41. For example, the depth information is information indicating a larger amount of projection with which an image seems to project from a display screen in a direction of the viewer as the luminance value is higher. Alternatively, the depth information is information indicating a larger amount of projection with which an image seems to project from a display screen in a direction of the viewer as the chroma value is higher.

According to the embodiment, the depth information generating circuit 44 generates the depth information by multiplying the combined image feature quantity generated by the feature quantity combining circuit 42 by a predetermined coefficient. More specifically, the depth information generating circuit 44 converts the combined image feature quantity output by the feature quantity combining circuit 42 into depth information as well as generation of another depth information based on the face region detection result output by the face region detecting circuit 43, and combines these depth information to output depth information of the current frame.

The parallax modulation circuit 45 adds a parallax to the image data output by the scaler 22 based on the depth information output by the depth information generating circuit 44 to generate and output the 3D image data indicating images viewed from two viewpoints.

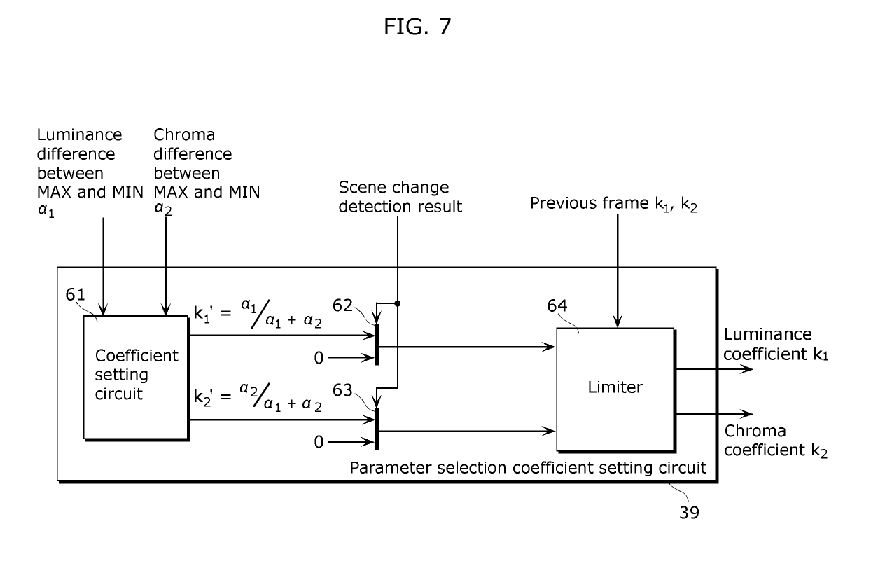

FIG. 7 is a block diagram illustrating an example of a configuration of the parameter selection coefficient setting circuit 39 according to the embodiment. The parameter selection coefficient setting circuit 39 is an example of a coefficient generator, and generates a luminance coefficient to be multiplied by the luminance integrated value output by the luminance value normalization circuit 41a, and a chroma coefficient to be multiplied by the chroma integrated value output by the chroma value normalization circuit 41b.

As illustrated in FIG. 7, the parameter selection coefficient setting circuit 39 includes a coefficient setting circuit 61, selectors 62 and 63, and a limiter 64. The parameter selection coefficient setting circuit 39 generates the luminance coefficient k₁ and the chroma coefficient k₂ of the current frame, from the luminance difference value α₁ and the chroma difference value α₂, a value of a scene-change detection result, and the luminance coefficient k₁ and the chroma coefficient k₂ of the previous frame.

The luminance coefficient k₁ is a value representing influence of a luminance value of a 2D image in generating the depth information, whereas a chroma coefficient k₂ is a value representing influence of a chroma value of the 2D image in generating the depth information. In other words, each of the coefficients indicates a larger influence over the depth information generated by the depth information generating circuit 44 in proportion to the size of each spreading width of the image feature quantity.

The coefficient setting circuit 61 is an example of a coefficient setter, and sets a luminance coefficient k₁′ and a chroma coefficient k₂′ to set the luminance coefficient to be larger than the chroma coefficient k₂′ when the luminance difference value α₁ is larger than the chroma difference value α₂, and to set the chroma coefficient k₂′ to be larger than the luminance coefficient k₁′ when the chroma difference value α₂ is larger than the luminance difference value α₁. More specifically, the coefficient setting circuit 61 receives the luminance difference value α₁ output by the luminance difference detecting circuit 33 and the chroma difference value α₂ output by the chroma difference detecting circuit 34, and generates the luminance coefficient k₁′ and the chroma coefficient k₂′ based on the following Equation 1.

[Math 1]

k₁′=α₁/α₁+α₂,k₂′=α₂/α₁+α₂ Equation 1

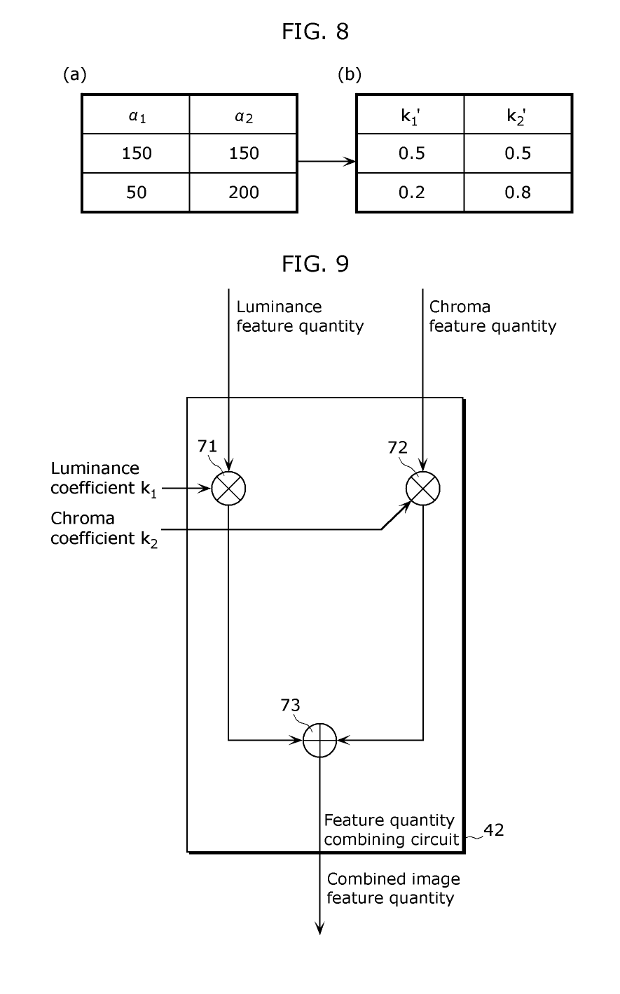

FIG. 8 illustrates an example of a coefficient setting process according to the embodiment. The coefficient setting circuit 61 outputs the luminance coefficient k₁′ and the chroma coefficient k₂′ as illustrated in (b) of FIG. 8 upon receipt of the luminance difference value α₁ and the chroma difference value α₂ as illustrated in (a) of FIG. 8. In the example of FIG. 8, a ratio of the luminance difference value α₁ to the chroma difference value α₂ that are received is equal to a ratio of the luminance coefficient k₁′ to the chroma coefficient k₂′ that are to be output. Furthermore, the luminance coefficient k₁′ and the chroma coefficient k₂′ make 1.

The image feature quantity having the smaller difference between the maximum value and the minimum value is greatly influenced by the normalization, and lacks reliability of the information. Thus, when the depth information is generated, as the influence of the image feature quantity having the smaller difference between the maximum value and the minimum value is larger, an unnatural depth is more likely to be generated.

Thus, the coefficient setting circuit 61 sets a coefficient to an image feature quantity having higher reliability in information, that is, the image feature quantity having a higher difference between the maximum value and the minimum value so that the image feature quantity has a larger influence in generating the depth information, thus reducing the unnaturalness in depth of a stereoscopic image.

The selectors 62 and 63 receive the scene-change detection result output by the scene change detecting circuit 38, and outputs 0 as the luminance coefficient k₁ and the chroma coefficient k₂ when the scene change detecting circuit 38 determines that the current image (frame) is an image in which the scene has been changed. The selectors 62 and 63 output the luminance coefficient k₁′ and the chroma coefficient k₂′ output by the coefficient setting circuit 61 as the luminance coefficient k₁ and the chroma coefficient k₂, respectively when the current image is not an image in which the scene has been changed. In other words, the selectors 62 and 63 output the luminance coefficient k₁′ and the chroma coefficient k₂′ output by the coefficient setting circuit 61 as the luminance coefficient k₁ and the chroma coefficient k₂, respectively only when the scene change detecting circuit 38 does not detect any change in the scene.

When a scene is changed and a depth of a gaze point is largely changed in a moment, there are cases where the viewer temporarily cannot view a stereoscopic image or feels tired. In particular, such phenomenon is noticeable: when the gaze point is far distant from the viewer with respect to the display surface of the display device and the image at the gaze point is suddenly and momentarily changed to an image that greatly projects toward the viewer according to the scene changed; or conversely, when the image at the gaze point is changed from the projecting image closer to the viewer to an image that depresses with an increasing distance from the viewer.

Thus, when the scene is changed, the 2D-3D conversion circuit 23 according to the embodiment performs processing so that the depth approximates 0, that is, processing for approximating the normal 2D image. The processing can suppress the variation in depth when the scene is changed.

The limiter 64 performs limiting processing. The limiting processing is to correct the luminance coefficient k₁′ and the chroma coefficient k₂′ set by the coefficient setting circuit 61 so that a difference between the luminance coefficient k₁′ and the luminance coefficient k₁ of the previous frame, and a difference between the chroma coefficient k₂′ and the chroma coefficient k₂ of the previous frame fall within a predetermined range.

More specifically, the limiter 64 performs the limiting processing on respective coefficients output by the selectors 62 and 63, based on the luminance coefficient k₁ and the chroma coefficient k₂ of the previous frame that are provided from the memory 40, and outputs the luminance coefficient k₁ and the chroma coefficient k₂ of the current frame. For example, in a state where a photographic image with poor luminance is displayed, when text with sufficient luminance is suddenly displayed on a part of the photographic image by an editing operation, the conversion focusing on chroma in generating the depth information is suddenly switched to the conversion focusing on luminance, thus leading to uncomfortable feeling. Here, the limiter 64 according to the embodiment can reduce the uncomfortable feeling by smoothing the differences between frames of the luminance coefficient k₁ and the chroma coefficient k₂.

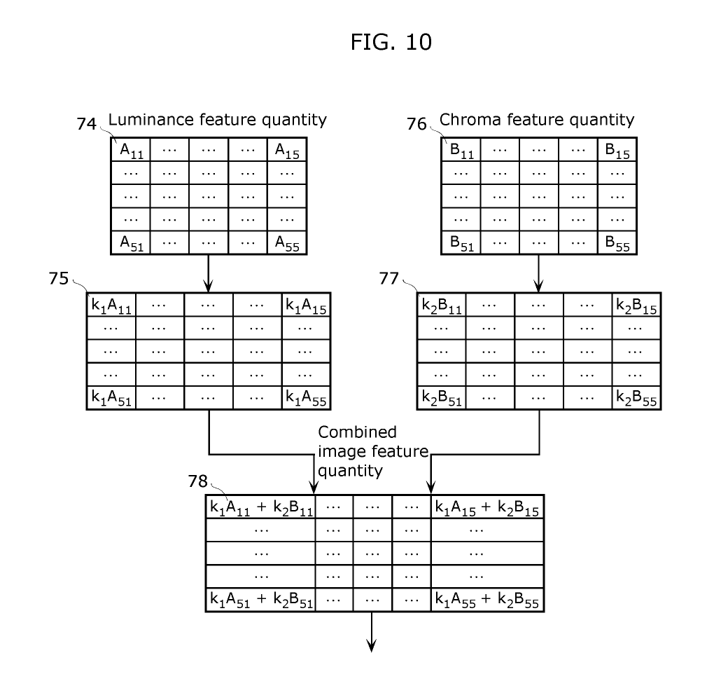

FIG. 9 illustrates an example of a configuration of the feature quantity combining circuit 42 according to the embodiment. FIG. 10 illustrates change in value by a feature quantity combining process according to the embodiment. An example of the process performed by the feature quantity combining circuit 42 will be described with reference to FIGS. 9 and 10.

The feature quantity combining circuit 42 is a circuit that combines image feature quantities of a plurality of types when the depth information is generated using the image feature quantities. For example, the image feature quantities of the types include the first image feature quantity and the second image feature quantity that are different from each other, more specifically, the luminance information and the chroma information as described above.

As illustrated in FIG. 9, the feature quantity combining circuit 42 includes multipliers 71 and 72, and an adder 73.

The multiplier 71 multiplies a luminance feature quantity 74 output from the luminance value normalization circuit 41a by the luminance coefficient k₁ output from the parameter selection coefficient setting circuit 39 to output a weighted luminance feature quantity 75 as illustrated in FIG. 10.

The multiplier 72 multiplies a chroma feature quantity 76 output from the chroma value normalization circuit 41b by the chroma coefficient k₂ output from the parameter selection coefficient setting circuit 39 to output a weighted chroma feature quantity 77 as illustrated in FIG. 10.

The adder 73 adds the luminance feature quantity 75 and the chroma feature quantity 77 output by the multiplier 71 and the multiplier 72, respectively, to output a combined image feature quantity 78.

As such, the feature quantity combining circuit 42 calculates a weighted sum so that the luminance integrated value output by the luminance value normalization circuit 41a is more heavily weighted than the chroma integrated value output by the chroma value normalization circuit 41b when the luminance difference value α₁ is larger than the chroma difference value α₂, and so that the chroma integrated value is more heavily weighted than the luminance integrated value when the chroma difference value α₂ is larger than the luminance difference value α₁.

In other words, the feature quantity combining circuit 42 calculates a weighted sum of the first image feature quantity and the second image feature quantity so that the first image feature quantity is more heavily weighted than the second image feature quantity when the first value representing a variation degree of the first image feature quantity is larger than the second value representing a variation degree of the second image feature quantity. Furthermore, the feature quantity combining circuit 42 calculates a weighted sum of the first image feature quantity and the second image feature quantity so that the second image feature quantity is more heavily weighted than the first image feature quantity when the second value is larger than the first value. Here, the first image feature quantity and the second image feature quantity include values normalized and not normalized using the first value and the second value, respectively.

When the image feature quantities used by the 2D-3D conversion circuit 23 are limited to one type, the 2D-3D conversion circuit 23 does not have to include the feature quantity combining circuit 42. In this case, the selective normalization circuit 41 outputs the image feature quantity to the depth information generating circuit 44 to be described next.

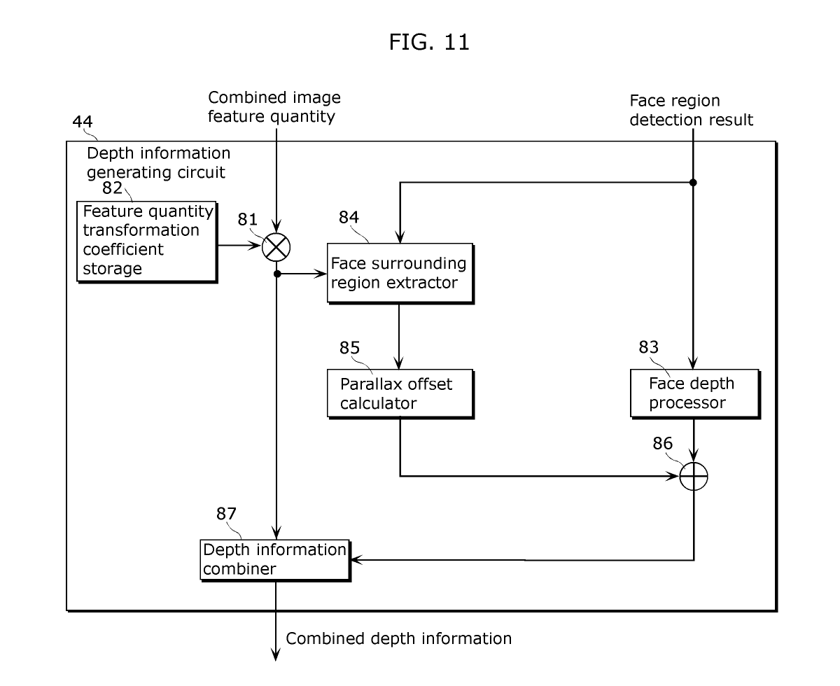

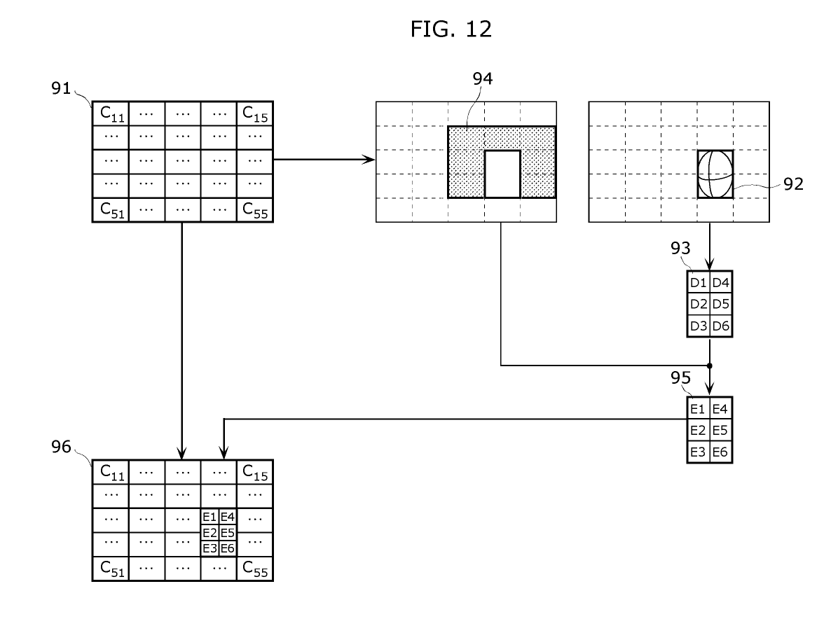

FIG. 11 illustrates an example of a configuration of the depth information generating circuit 44 according to the embodiment. FIG. 12 illustrates an example of a depth information generating process according to the embodiment. Hereinafter, the depth information generating process will be described with reference to FIGS. 11 and 12.

As illustrated in FIG. 11, the depth information generating circuit 44 includes a multiplier 81, a feature quantity transformation coefficient storage 82, a face depth processor 83, a face surrounding region extractor 84, a parallax offset calculator 85, an adder 86, and a depth information combiner 87.

The multiplier 81 is an example of a second depth information generator, and generates the second depth information that is depth information of a region at least other than a face region. More specifically, the multiplier 81 converts a feature quantity into depth information 91 by multiplying the combined image feature quantity output from the feature quantity combining circuit 42 by a predetermined coefficient, and outputs the depth information 91. The multiplier 81 according to the embodiment generates, as the depth information 91, depth information of the whole current frame, that is, depth information of an entire image including the face region.

The feature quantity transformation coefficient storage 82 is a memory for storing a coefficient to be multiplied by an image feature quantity.

The face depth processor 83 is an example of a first depth information generator, and generates first depth information that is depth information of the face region. More specifically, the face depth processor 83 receives a face region detection result 92 output by the face region detecting circuit 43, and generates face-region depth information 93.

The face depth processor 83 records, in advance, depths D1 to D6 to be generated therein. More specifically, the face depth processor 83 records, in advance, a plurality of depth information according to the orientation of a face and the size of a face region. The face depth processor 83 selects appropriate depth information from the plurality of depth information, based on the face region detection result 92. In the example of FIG. 12, the face-region depth information 93 is split into six, which indicates that the face-region depth information 93 is split into smaller regions than those of the depth information 91.

Accordingly, more accurate depth can be represented for the face surrounding region. Since faces are in general easily gazed by observers, the uncomfortable feeling can be improved with partial accurate representation of a depth.

Furthermore, when the depth information is generated according to luminance and chroma, a skin color and a black color are recognized as having different depths. However, when the hair, the eyes, and others of a subject are black, the hair and the eyes are different in depth information from the skin. Here, exclusive treatment on the face enables processing in which the skin, the hair, and the eyes are handled as one object, thus improving the quality of depth information.

The face surrounding region extractor 84 extracts a surrounding region that surrounds a face region. More specifically, the face surrounding region extractor 84 receives the face region detection result 92, and extracts a value of the depth information 91 in a face surrounding region that is a region above and to the left and right of the face region, as indicated in a face surrounding region 94. The face surrounding region extractor 84 outputs the extracted value to the parallax offset calculator 85.

The parallax offset calculator 85 calculates an offset value for approximating the depth information of the face region to the depth information of the surrounding region. More specifically, the parallax offset calculator 85 calculates an average of the values extracted by the face surrounding region extractor 84, and outputs the average as a parallax offset value. In other words, the parallax offset value is an average of a plurality of depth information of a surrounding region.

The adder 86 adds the offset value calculated by the parallax offset calculator 85 to the face-region depth information 93 to generate offset face-region depth information. In other words, the face-region depth information 93 corresponds to depth information when the face is located on a surface with no parallax (for example, a surface of a display), and the stereoscopic effect that suits the surrounding region can be represented by addition of the parallax offset value.

The depth information combiner 87 combines the first depth information that is depth information of a face region and the second depth information that is depth information of a region at least other than the face region. More specifically, the depth information combiner 87 overwrites the offset face-region depth information 95 that is an example of the first depth information with the depth information 91 that is an example of the second depth information to generate combined depth information 96.

Here, without the parallax offset calculator 85, the face would be always in the vicinity of a region with no depth, that is, in the vicinity of a display surface of the image display. However, when the surrounding region of the face projects with respect to the display surface, processing is performed so that the face is distant from the surrounding region.

Normally, a region above the face region and a region to the left and right of the face region are often deeper than the face. Thus, an image with an unnatural depth is viewed. Thus, more natural depth information can be generated by first calculating a depth of a surrounding region of a face region and projecting an image with a depth corresponding to the face.

The face surrounding region extractor 84 may extract a region immediately below the face region as the face surrounding region 94. Since it is more likely that a region to be extracted includes the body, a depth of the face is determined with respect to the body.

When the processing on a face surrounding region is not performed, the depth information combiner 87 is not necessary. When the parallax offset processing is not performed, the face surrounding region extractor 84, the parallax offset calculator 85, and the adder 86 are not necessary.

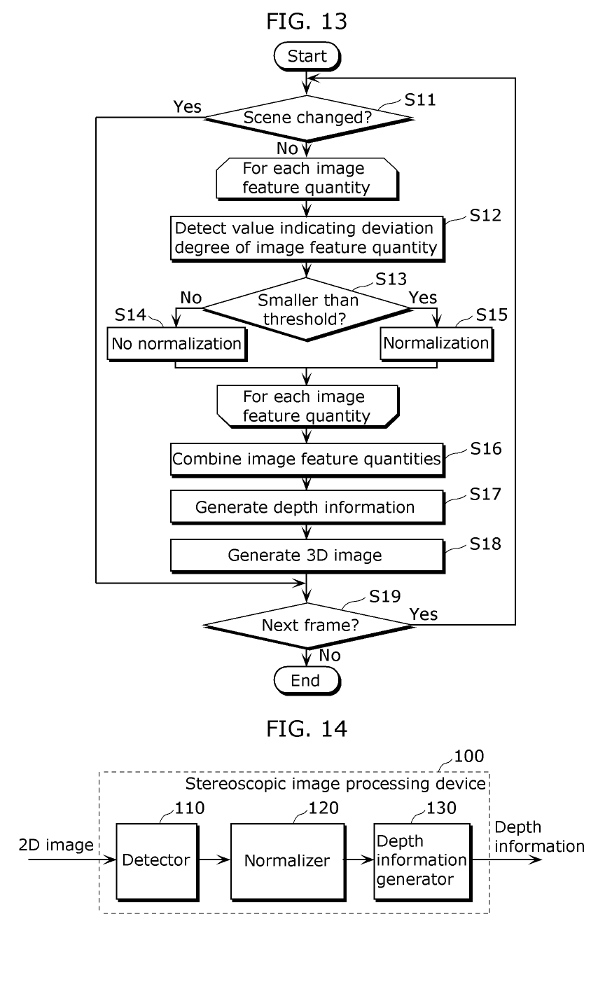

Here, operations of the stereoscopic image processing device (2D-3D conversion circuit 23) according to the embodiment will be described. FIG. 13 is a flowchart indicating an example of processes performed by the stereoscopic image processing device according to the embodiment.

When the 2D-3D conversion circuit 23 receives the current frame of a 2D image, the scene change detecting circuit 38 determines whether or not the current frame is a frame in which a scene has been changed (S11). When the scene change detecting circuit 38 determines that the current frame is the frame in which the scene has been changed (Yes at S11) and a next frame is present (Yes at S19), the processing continues using the next frame as the current frame.

When the scene change detecting circuit 38 determines that the current frame is not the frame in which the scene has been changed (No at S11), a value indicating a variation degree of the image feature quantity is detected (S12). For example, the luminance difference detecting circuit 33 detects the luminance difference value that is a difference between the maximum value and the minimum value of a luminance value, as a value indicating the variation degree.

Next, it is determined whether or not the value indicating the variation degree is smaller than a threshold (S13). For example, the luminance normalization selecting circuit 35 determines whether or not a luminance difference value is smaller than a threshold. When it is determined that the value indicating the variation degree is larger than or equal to the threshold (No at S13), the selective normalization circuit 41 does not normalize the image feature quantity (S14). For example, the luminance value normalization circuit 41a does not normalize a luminance integrated value for each block, and outputs, to the feature quantity combining circuit 42, the luminance integrated value as a luminance feature quantity.

When it is determined that the value indicating the variation degree is smaller than the threshold (Yes at S13), the selective normalization circuit 41 normalizes the image feature quantity (S15). For example, the luminance value normalization circuit 41a normalizes the luminance integrated value for each block, and outputs, to the feature quantity combining circuit 42, the luminance integrated value as a luminance feature quantity.

Detection of the value indicating the variation degree (S12), determination on necessity of normalization (S13), and the normalization (S15) are performed for each image feature quantity. Since the 2D-3D conversion circuit 23 according to the embodiment uses luminance and chroma as image feature quantities, it performs the same processing on, for example, the chroma.

More specifically, the chroma difference detecting circuit 34 detects a chroma difference value that is a difference between the maximum value and the minimum value of a chroma value, as a value indicating the variation degree (S12). For example, the chroma normalization selecting circuit 36 determines whether or not the chroma difference value is smaller than a threshold (S13).

When it is determined that the chroma difference value is larger than or equal to the threshold (No at S13), the chroma value normalization circuit 41b does not normalize a chroma integrated value for each block, and outputs, to the feature quantity combining circuit 42, the chroma integrated value as a chroma feature quantity (S14). When it is determined that the chroma difference value is smaller than the threshold (Yes at S13), the chroma value normalization circuit 41b normalizes the chroma integrated value for each block, and outputs, to the feature quantity combining circuit 42, the chroma integrated value as a chroma feature quantity (S15).

The feature quantity combining circuit 42 combines the image feature quantities (S16). For example, the feature quantity combining circuit 42 calculates a weighted sum of a luminance feature quantity and a chroma feature quantity to generate a combined image feature quantity.

Next, the depth information generating circuit 44 generates the depth information for converting the current frame into a 3D image, based on the combined image feature quantity (S17). For example, the depth information generating circuit 44 generates the depth information by multiplying the combined image feature quantity by a predetermined coefficient. Here, the depth information generating circuit 44 may generate depth information exclusive to a face region.

Finally, the parallax modulation circuit 45 generates the 3D image from the current frame based on the depth information (S18). For example, the parallax modulation circuit 45 generates a left-eye image and a right-eye image that have a parallax, based on the current frame and the depth information, and outputs the images as a 3D image.

When the next frame is present (Yes at S19), the processes (S11 to S19) are repeated using the next frame as the current frame. When the next frame is not present (No at S19), the processes end.

As described above, the stereoscopic image processing device according to the embodiment is a stereoscopic image processing device for converting a 2D image into a 3D image, and includes a detector, a normalizer, and a depth information generator. The detector includes, for example, the luminance difference detecting circuit 33 and the chroma difference detecting circuit 34, and detects a value indicating a variation degree of an image feature quantity within a current frame to be processed of the 2D image. The normalizer is, for example, the selective normalization circuit 41, and normalizes the image feature quantity to approximate the value detected by the detector to a threshold of the variation degree and outputs the normalized image feature quantity when the value is smaller than the threshold of the variation degree; and (b) does not normalize the image feature quantity and outputs the image feature quantity when the value is larger than or equal to the threshold of the variation degree. The depth information generator is, for example, the depth information generating circuit 44, and generates the depth information for converting the 2D image into the 3D image, based on the image feature quantity output by the normalizer, that is, the normalized image feature quantity or the image feature quantity that is not normalized.

When a value indicating a variation degree of an image feature quantity is smaller than a threshold, the normalizer normalizes the image feature quantity so that the value approximates the threshold. Thus, the stereoscopic image processing device according to the embodiment can appropriately normalize the image feature quantity. In other words, it is possible to prevent the image feature quantity with insufficient information from being normalized (expanded) more than necessary, and to suppress decrease in the reliability of the image feature quantity.

Thus, use of an image feature quantity with low reliability can be suppressed when depth information is generated, and depth information with high precision can be generated. Thus, the stereoscopic image processing device according to the embodiment can improve the quality of a stereoscopic image.

Furthermore, the stereoscopic image processing device according to the embodiment includes the parameter selection coefficient setting circuit 39 and the feature quantity combining circuit 42, and generates depth information using an image feature quantity with higher reliability when a plurality of image feature quantities is used for generating the depth information. Accordingly, the precision of the depth information of a stereoscopic image can be further increased.

Furthermore, in the stereoscopic image processing device, the depth information generating circuit 44 generates depth information exclusive to a face. Accordingly, the stereoscopic image with higher precision can be generated in the vicinity of the face that is noticeable.

Furthermore, the stereoscopic image processing device includes the scene change detecting circuit 38, and approximates the depth to 0 when a scene is changed, in order to prevent abrupt change in the depth by approximating the image to the 2D image. Accordingly, the eye fatigue in changing the scene can be reduced.

The stereoscopic image processing device and the stereoscopic image processing method according to the present invention are hereinbefore described based on the embodiment. The present invention is not limited to the embodiment. The modifications conceived by those skilled in the art are included within the scope of the present invention, as long as they are not departing from the purport of the present invention.

Although a difference between the maximum value and the minimum value of an image feature quantity is used as a value indicating a variation degree of the image feature quantity according to the embodiment, a variance of the image feature quantity may be used. For example, the 2D-3D conversion circuit 23 includes a luminance variance detecting circuit and a chroma variance detecting circuit instead of the luminance difference detecting circuit 33 and the chroma difference detecting circuit 34.

The luminance variance detecting circuit detects a variance of luminance information (luminance variance), and outputs the variance to the luminance normalization selecting circuit 35 and the parameter selection coefficient setting circuit 39. The luminance normalization selecting circuit 35 compares the luminance variance with a threshold. The luminance normalization selecting circuit 35 determines not to normalize the luminance variance when the luminance variance is larger than or equal to the threshold, whereas it determines to normalize the luminance variance when the luminance variance is smaller than the threshold.

The chroma variance detecting circuit detects a variance of chroma information (chroma variance), and outputs the variance to the chroma normalization selecting circuit 36 and the parameter selection coefficient setting circuit 39. The chroma normalization selecting circuit 36 compares the chroma variance with a threshold. The chroma normalization selecting circuit 36 determines not to normalize the chroma variance when the chroma variance is larger than or equal to the threshold, whereas it determines to normalize the chroma variance when the chroma variance is smaller than the threshold.

Furthermore, the parameter selection coefficient setting circuit 39 generates the luminance coefficient k₁ and the chroma coefficient k₂ based on the luminance variance and the chroma variance, respectively. The details of the processing are the same as the processing using the luminance difference value and the chroma difference value.

In other words, the parameter selection coefficient setting circuit 39 generates the luminance coefficient k₁ and the chroma coefficient k₂ so that the luminance feature quantity is more heavily weighted than the chroma feature quantity when the luminance variance is larger than the chroma variance. Furthermore, the parameter selection coefficient setting circuit 39 generates the luminance coefficient k₁ and the chroma coefficient k₂ so that the chroma feature quantity is more heavily weighted than the luminance feature quantity when the chroma variance is larger than the luminance variance.

Accordingly, the image feature quantity having a larger variance can greatly influence generation of the depth information. Thus, since influence of an image feature quantity having a smaller variance and insufficient information over the depth information can be reduced, reliability of the depth information can be increased.

Furthermore, a luminance contrast or an amount of a high-frequency component included in each block may be used as the image feature quantity, instead of the luminance information and the chroma information included in the current frame.

The present invention may be implemented not only as a stereoscopic image processing device and a stereoscopic image processing method as described above but also as a program causing a computer to execute the stereoscopic image processing method according to the embodiment. Furthermore, the present invention may be implemented as a recording medium on which the program is recorded, such as a computer-readable CD-ROM. Furthermore, the present invention may be implemented as information, data, or a signal each indicating the program. Furthermore, these program, information, data, and signal may be distributed through a communication network, such as the Internet.

More specifically, a part or all of the constituent elements included in the stereoscopic image processing device may be configured from a single System-Large-Scale Integration (LSI) according to the present invention. The System-LSI is a super-multi-function LSI manufactured by integrating constituent elements on one chip, and is specifically a computer system configured by including a microprocessor, a ROM, and a RAM.

Each of the processors included in the stereoscopic image processing device according to the embodiment is typically achieved in the form of an integrated circuit or a Large Scale Integrated (LSI) circuit. Each of the processors may be made into one chip individually, or a part or an entire thereof may be made into one chip.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. A field programmable gate array (FPGA) that is programmable after manufacturing an LSI or a reconfigurable processor allowing re-configuration of the connection or configuration of an LSI can be used for the same purpose.

In the future, with advancement in semiconductor technology, a brand-new technology may replace LSI. The processors can be integrated using such a technology. One such possibility is that the present invention is applied to biotechnology.

Furthermore, a part or an entire of the functions of the stereoscopic image processing device according to the embodiment may be implemented by a processor, such as a CPU, causing a program to execute the functions.

Furthermore, the present invention may be the program, or a recording medium on which the program is recorded. It is obvious that such a program can be distributed via transmission media, such as the Internet.

Furthermore, the values described above are exemplifications for specifically describing the present invention, and the present invention is not limited by the exemplified values.

Furthermore, although the embodiment is implemented using hardware and/or software, a configuration using the hardware may be implemented using the software, and a configuration using the software may be implemented using the hardware.

Furthermore, the configuration of the stereoscopic image processing device is an exemplification for specifically describing the present invention, and the stereoscopic image processing device does not have to include all the constituent elements. In other words, the stereoscopic image processing device according to the embodiment has only to include the minimum constituent elements that can achieve the advantages of the present invention. For example, the stereoscopic image processing device may be implemented by a configuration of FIG. 14.

FIG. 14 is an example of a configuration of a stereoscopic image processing device 100 according to a modification of the embodiment. The stereoscopic image processing device 100 is a device that converts a 2D image into a 3D image. As illustrated in FIG. 14, the stereoscopic image processing device 100 includes a detector 110, a normalizer 120, and a depth information generator 130.

The detector 110 detects a value indicating a variation degree of an image feature quantity within the current frame of the 2D image. The detector 110 may include, for example, the luminance extractor 29, the chroma extractor 30, the luminance difference detecting circuit 33, and the chroma difference detecting circuit 34 that are illustrated in FIG. 4.

The normalizer 120 (a) normalizes the image feature quantity to approximate the value detected by the detector 110 to a threshold of the variation degree and outputs the normalized image feature quantity when the value is smaller than the threshold of the variation degree; and (b) does not normalize the image feature quantity and outputs the image feature quantity when the value is larger than or equal to the threshold of the variation degree. The normalizer 120 may include, for example, the luminance integrated value calculation circuit 31, the chroma integrated value calculation circuit 32, the luminance normalization selecting circuit 35, the chroma normalization selecting circuit 36, the predetermined value storage 37, and the selective normalization circuit 41 that are illustrated in FIG. 4.

The depth information generator 130 generates depth information for converting the 2D image into the 3D image, based on the image feature quantity output by the normalizer 120. The depth information generator 130 may include, for example, the depth information generating circuit 44 in FIG. 4.

Furthermore, the stereoscopic image processing method performed by the stereoscopic image processing device is an exemplification for specifically describing the present invention, and the stereoscopic image processing method does not have to include all the steps. In other words, the stereoscopic image processing method according to the embodiment has only to include the minimum steps that can achieve the advantages of the present invention.

For example, when only one image feature quantity is used for generating the depth information, there is no need to combine image feature quantities (S16). Furthermore, the order in which the steps are performed is an exemplification for specifically describing the present invention, and other orders may be used. Furthermore, part of the steps may be performed in parallel with other steps.

### INDUSTRIAL APPLICABILITY

The stereoscopic image processing device and the stereoscopic image processing method according to the present invention have an advantage of fully improving the image quality of a stereoscopic image, and are applicable to, for example, stereoscopic image display devices such digital televisions, and stereoscopic image playback apparatuses such as digital video recorders.

### REFERENCE SIGNS LIST

1 Player
2 Stereoscopic image display device
3 Active shutter glasses
4 Left-eye image
5 Right-eye image
11 External signal receiver
12 Image signal processor
13 Image display
14 Audio signal processor
15 Audio outputter
21 IP conversion circuit
22 Scaler
23 2D-3D conversion circuit
24 Image quality improving circuit
29 Luminance extractor
30 Chroma extractor
31 Luminance integrated value calculation circuit
32 Chroma integrated value calculation circuit
33 Luminance difference detecting circuit
34 Chroma difference detecting circuit
35 Luminance normalization selecting circuit
36 Chroma normalization selecting circuit
37 Predetermined value storage
38 Scene change detecting circuit
39 Parameter selection coefficient setting circuit
40 Memory
41 Selective normalization circuit
41a Luminance value normalization circuit
41b Chroma value normalization circuit
42 Feature quantity combining circuit
43 Face region detecting circuit
44 Depth information generating circuit
45 Parallax modulation circuit
51 Two-dimensional image (2D image)
52 Block
61 Coefficient setting circuit
62, 63 Selector
64 Limiter
71, 72, 81 Multiplier
73, 86 Adder
74, 75 Luminance feature quantity
76, 77 Chroma feature quantity
78 Combined feature quantity
82 Feature quantity transformation coefficient storage
83 Face depth processor
84 Face surrounding region extractor
85 Parallax offset calculator
87 Depth information combiner
91 Depth information
92 Face region detection result
93 Face-region depth information
94 Face surrounding region
95 Offset face region depth information
96 Combined depth information
100 Stereoscopic image processing device
110 Detector
120 Normalizer
130 Depth information generator

1. A stereoscopic image processing device that converts a two-dimensional (2D) image into a three-dimensional (3D) image, the device comprising:
a detector detecting a value indicating a variation degree of an image feature quantity within a current frame to be processed of the 2D image;
a normalizer: (a) normalizing the image feature quantity to approximate the value detected by the detector to a threshold of the variation degree and outputting the normalized image feature quantity when the value is smaller than the threshold of the variation degree; and (b) not normalizing the image feature quantity and outputting the image feature quantity when the value is larger than or equal to the threshold of the variation degree; and
a depth information generator generating depth information for converting the 2D image into the 3D image, based on the image feature quantity output by the normalizer.

2. The stereoscopic image processing device according to claim 1,
wherein the image feature quantity includes a first image feature quantity and a second image feature quantity that are different from each other,
the detector detects a first value indicating a variation degree of the first image feature quantity, and a second value indicating a variation degree of the second image feature quantity,
the normalizer:
(i) (a) normalizes the first image feature quantity to approximate the first value detected by the detector to a first threshold of the variation degree of the first image feature quantity and outputs the normalized first image feature quantity when the first value is smaller than the first threshold of the variation degree, and (b) does not normalize the first image feature quantity and outputs the first image feature quantity when the first value is larger than or equal to the first threshold of the variation degree of the first image feature quantity; and
(ii) (a) normalizes the second image feature quantity to approximate the second value detected by the detector to a second threshold of the variation degree of the second image feature quantity and outputs the normalized second image feature quantity when the second value is smaller than the second threshold of the variation degree, and (b) does not normalize the second image feature quantity and outputs the second image feature quantity when the second value is larger than or equal to the second threshold of the variation degree of the second image feature quantity,
the stereoscopic image processing device further comprises a combiner calculating a weighted sum of the first image feature quantity and the second image feature quantity that are output by the normalizer, and generating a combined image feature quantity,
the depth information generator generates the depth information by multiplying the combined image feature quantity by a predetermined coefficient, and
the combiner calculates the weighted sum (a) weighting the first image feature quantity more heavily than the second image feature quantity when the first value is larger than the second value, and (b) weighting the second image feature quantity more heavily than the first image feature quantity when the second value is larger than the first value.

3. The stereoscopic image processing device according to claim 2,
wherein the detector detects, as the first value, a difference between a maximum value and a minimum value of the first image feature quantity or a variance of the first image feature quantity, and detects, as the second value, a difference between a maximum value and a minimum value of the second image feature quantity or a variance of the second image feature quantity.

4. The stereoscopic image processing device according to claim 1,
wherein the image feature quantity indicates at least one of luminance information and chroma information within the current frame, and
the detector detects, as the value indicating the variation degree, at least one of a luminance difference value and a chroma difference value, the luminance difference value being a difference between a maximum value and a minimum value of the luminance information, and the chroma difference value being a difference between a maximum value and a minimum value of the chroma information.

5. The stereoscopic image processing device according to claim 4,
wherein the normalizer normalizes at least one of the luminance information and the chroma information to set at least one of the luminance difference value and the chroma difference value to be equal to the threshold of the variation degree, when the at least one of the luminance difference value and the chroma difference value is smaller than the threshold of the variation degree.

6. The stereoscopic image processing device according to claim 5,
wherein the detector includes:
a luminance extractor extracting the luminance information; and
a luminance difference calculator calculating the difference between the maximum value and the minimum value of the luminance information extracted by the luminance extractor, to detect the luminance difference value,
the normalizer includes:
a storage storing the threshold;
a luminance comparator comparing the luminance difference value with the threshold to determine whether or not the normalizer normalizes the luminance information;
a luminance value integrator dividing the luminance information into a plurality of blocks and integrating luminance values for each of the blocks to calculate a luminance integrated value for the block; and
a luminance value normalizer: (a) normalizing and outputting the luminance integrated value when the luminance comparator determines that the normalizer normalizes the luminance information; and (b) not normalizing the luminance integrated value and outputting the luminance integrated value when the luminance comparator determines that the normalizer does not normalize the luminance information, and
the depth information generator generates the depth information based on the luminance integrated value output by the luminance value normalizer.

7. The stereoscopic image processing device according to claim 6,
wherein the detector further includes:
a chroma extractor extracting the chroma information; and
a chroma difference calculator calculating the difference between the maximum value and the minimum value of the chroma information extracted by the chroma extractor, to detect the chroma difference value,
the normalizer further includes:
a chroma comparator comparing the chroma difference value with the threshold of the variation degree to determine whether or not the normalizer normalizes the chroma information;
a chroma value integrator dividing the chroma information into a plurality of blocks and integrate chroma values for each of the blocks to calculate a chroma integrated value for the block; and
a chroma value normalizer: (a) normalizing and outputting the chroma integrated value when the chroma comparator determines that the normalizer normalizes the chroma information; and (b) not normalizing the chroma integrated value and outputting the chroma integrated value when the chroma comparator determines that the normalizer does not normalize the chroma information,
the stereoscopic image processing device further comprises a combiner calculating a weighted sum of the luminance integrated value output by the luminance value normalizer and the chroma integrated value output by the chroma value normalizer, to generate a combined image feature quantity, and
the depth information generator generates the depth information by multiplying, by a predetermined coefficient, the combined image feature quantity generated by the combiner.

8. The stereoscopic image processing device according to claim 7,
wherein the combiner calculates the weighted sum weighting the luminance integrated value output by the luminance value normalizer more heavily than the chroma integrated value output by the chroma value normalizer when the luminance difference value is larger than the chroma difference value, and weighting the chroma integrated value more heavily than the luminance integrated value when the chroma difference value is larger than the luminance difference value.

9. The stereoscopic image processing device according to claim 8, further comprising:
a coefficient generator generating a luminance coefficient to be multiplied by the luminance integrated value output by the luminance value normalizer, and a chroma coefficient to be multiplied by the chroma integrated value output by the chroma value normalizer; and
a memory storing the luminance coefficient and the chroma coefficient that are used for a frame previous to the current frame, and
the coefficient generator including:
a coefficient setter setting the luminance coefficient and the chroma coefficient to set the luminance coefficient to be larger than the chroma coefficient when the luminance difference value is larger than the chroma difference value, and to set the chroma coefficient to be larger than the luminance coefficient when the chroma difference value is larger than the luminance difference value; and
a limiter correcting the luminance coefficient and the chroma coefficient set by the coefficient setter to maintain, within a predetermined range, a difference between the luminance coefficient set by the coefficient setter and the luminance coefficient used for the previous frame and a difference between the chroma coefficient set by the coefficient setter and the chroma coefficient used for the previous frame.

10. The stereoscopic image processing device according to claim 4,
wherein the detector includes:
a chroma extractor extracting the chroma information; and
a chroma difference calculator calculating the difference between the maximum value and the minimum value of the chroma information extracted by the chroma extractor, to detect the chroma difference value,
the normalizer includes:
a storage storing the threshold;
a chroma comparator comparing the chroma difference value with the threshold to determine whether or not the normalizer normalizes the chroma information;
a chroma value integrator dividing the chroma information into a plurality of blocks and integrate chroma values for each of the blocks to calculate a chroma integrated value for the block; and
a chroma value normalizer: (a) normalizing and outputting the chroma integrated value when the chroma comparator determines that the normalizer normalizes the chroma information; and (b) not normalizing the chroma integrated value and outputting the chroma integrated value when the chroma comparator determines that the normalizer does not normalize the chroma information, and
the depth information generator generates the depth information based on the chroma integrated value output by the chroma value normalizer.

11. The stereoscopic image processing device according to claim 1,
wherein the image feature quantity indicates at least one of luminance information and chroma information within the current frame, and
the detector detects, as the value indicating the variation degree, at least one of a variance of the luminance information and a variance of the chroma information.

12. The stereoscopic image processing device according to claim 1, further comprising
a scene change detector determining whether or not the current frame is a frame in which a scene has been changed, and
the depth information generator generates the depth information only when the scene change detector determines that the current frame is not the frame in which the scene has been changed, out of cases where the scene change detector determines that the current frame is the frame in which the scene has been changed and that the current frame is not the frame in which the scene has been changed.

13. The stereoscopic image processing device according to claim 1, further comprising
a face detector detecting a face region from the current frame,
wherein the depth information generator includes:
a first depth information generator generating first depth information that is depth information of the face region;
a second depth information generator generating second depth information that is depth information of a region at least other than the face region, based on the image feature quantity output by the normalizer; and
a depth information combiner combining the first depth information and the second depth information to generate the depth information for converting the 2D image into the 3D image.

14. The stereoscopic image processing device according to claim 13,
wherein the depth information generator further includes:
a face surrounding region extractor extracting a surrounding region that surrounds the face region; and
an offset calculator obtaining depth information of the surrounding region from the second depth information, and calculating an offset value for approximating the depth information of the face region to the obtained depth information of the surrounding region, based on the depth information of the surrounding region, and
the first depth information generator generates the first depth information based on predetermined depth information and the offset value.

15. The stereoscopic image processing device according to claim 14,
wherein the face surrounding region extractor extracts, as the surrounding region, a region below the face region or a region above and to the left and right of the face region.

16. The stereoscopic image processing device according to claim 1,
wherein the stereoscopic image processing device is an integrated circuit.

17. A stereoscopic image processing method for converting a two-dimensional (2D) image into a three-dimensional (3D) image, the method comprising:
detecting a value indicating a variation degree of an image feature quantity within a current frame to be processed of the 2D image;
(a) normalizing the image feature quantity to approximate the value detected in the detecting to a threshold of a variation degree and outputting the normalized image feature quantity when the value is smaller than the threshold of the variation degree; and (b) not normalizing the image feature quantity and outputting the image feature quantity when the value is larger than or equal to the threshold of the variation degree; and
generating depth information for converting the 2D image into the 3D image, based on the image feature quantity output in the normalizing.

18. A non-transitory computer-readable recording medium on which a program is recorded, the program causing a computer to execute the stereoscopic image processing method according to claim 17.
